(19) United States
(12) Patent Application Publication
(10) Pub. No.: US 2014/0341488 A1
(43) Pub. Date: Nov. 20, 2014

(54) OIL-RETAINING BEARING AND FIXING STRUCTURE THEREOF

(71) Applicant: ASIA VITAL COMPONENTS CO., LTD., New Taipei City (TW)

(72) Inventor: Chun-Ming Wu, New Taipei City (TW)

(21) Appl. No.: 13/894,402

(22) Filed: May 14, 2013

(51) Int. Cl. F16C 33/02

(52) U.S. Cl. CPC F16C 33/02
USPC 384/322

(57) ABSTRACT

An oil-retaining bearing and a fixing structure thereof. The fixing structure includes: a base seat having a bearing cup formed with a bearing hole; a bearing main body disposed in the bearing hole, the bearing main body having an outer circumference and a shaft hole formed between a top section and a bottom section, the bearing main body being further formed with a stepped rest section between the outer circumference and the top section; and a fixing member formed with a fixing section and a restriction section. The fixing section is disposed in the bearing cup in abutment with the rest section. The restriction section is positioned at the top end of the bearing cup. The fixing section is positioned between the bearing main body and the bearing cup to fix the bearing main body, whereby the support of the bearing main body is enhanced to reduce the friction.

### BACKGROUND OF THE INVENTION

1. Field of the Invention

The present invention relates generally to an oil-retaining bearing, and more particularly to an oil-retaining bearing and a fixing structure thereof, which can enhance the support of the bearing main body so as to reduce the friction and minimize the noise.

2. Description of the Related Art

Along with the advance of sciences and technologies, the operation performances of the electronic components have become higher and higher. Accordingly, higher and higher heat dissipation efficiency of the heat dissipation unit is required for the electronic components.

With a computer mainframe taken as an example, most of the heat is generated by the central processing unit (CPU) of the computer mainframe. In the case that the heat is not dissipated in time, the temperature of the CPU will rise to cause deterioration of the execution performance of the CPU. When the heat accumulates to an extent higher than the tolerance limit, the computer will crash or even burn out. Moreover, in order to solve the problem of electromagnetic radiation, the computer mainframe is generally enclosed in a computer case. Therefore, it has become a critical issue how to quickly dissipate the heat generated by the CPU and other heat generation components.

On the other hand, an ordinary large-scale electronic device such as a working station or a server will generate high heat in operation. When the operation temperature exceeds a certain working temperature, the working performance of the working station or server will be affected at high temperature. In some more serious cases, the electronic components in the working station or server may burn out to cause malfunction. The temporary crush or burnout of the working station or server will lead to great loss, especially in the case that many databases or files are stored in the working station or server. Therefore, it is a very important link of setup of the working station or server how to efficiently dissipate the heat and keep the temperature within the range of working temperature.

Accordingly, currently, high-performance heat dissipation unit has become one of the most important focuses of research and development in this field. The heat generation electronic components are provided with the heat dissipation unit for dissipating the heat generated by the electronic components. In general, the heat dissipation unit includes a heat sink or radiating fin assembly and a cooling fan mounted thereon for dissipating the heat. Moreover, there is a trend to miniaturize the electronic devices. Accordingly, the thickness of the cooling fan has become thinner and thinner.

Please refer to FIG. 1, which is a sectional assembled view of a conventional cooling fan. The conventional cooling fan 1 includes a base seat 11, a rotor assembly 12 and a stator assembly 13. The base seat 11 has a bearing cup 111 formed with an internal sink 112 in which a bearing 113 is disposed. The bearing 113 is fixedly disposed in the bearing cup 111 by means of an assembling member 114 and a retainer ring 115. One end of the assembling member 114 is positioned in the sink of the bearing cup 111, while the other end of the assembling member 114 is engaged with the bearing 113 to fix the bearing on the bearing cup. The rotor assembly 12 has a hub 121 and a shaft rod 122. The shaft rod 122 is inserted in the bearing 113. When the cooling fan 1 operates, the shaft rod 122 of the rotor assembly 12 is rotated relative to the bearing 113. The cooling fan 1 has a fixed thickness so that the gap between the assembling member 114 and the hub 121 is so small that the assembling member 114 and the hub 121 are likely to abrade each other. In order to avoid the abrasion between the assembly member and the hub, it is necessary to minify the size of the bearing. In this case, the support force between the shaft rod and the bearing is reduced. As a result, when the shaft rod rotates within the bearing, the shaft rod tends to shake to make noise. Also, after minified, the amount of the lubricant retained in the bearing will be decreased. Under such circumstance, the lubrication will be reduced.

According to the above, the conventional technique has the following shortcomings:

1. The support force between the shaft rod and the bearing is reduced.

2. When the shaft rod rotates within the bearing, the shaft rod tends to shake to make noise.

3. The amount of the lubricant retained in the bearing is decreased and the lubrication is reduced.

### SUMMARY OF THE INVENTION

It is therefore a primary object of the present invention to provide an oil-retaining bearing and a fixing structure thereof, which can enhance the support of the bearing main body so as to reduce the friction and minimize the noise.

It is a further object of the present invention to provide the above oil-retaining bearing and the fixing structure thereof, which can increase the amount of the lubricant retained in the bearing main body and maintain the lubrication between the bearing main body and the shaft.

To achieve the above and other objects, the oil-retaining bearing of the present invention includes a bearing main body having a top section and a bottom section. The bearing main body has an outer circumference and a shaft hole formed between the top section and the bottom section. The bearing main body is further formed with a stepped rest section between the outer circumference and the top section.

The fixing structure of the oil-retaining bearing includes a base seat, a bearing main body and at least one fixing member. A bearing cup extends from one side of the base seat. The bearing cup has a bearing hole, a fixed end and a top end. The fixed end is connected with the base seat. The bearing main body is disposed in the bearing hole of the bearing cup. The bearing main body has a top section and a bottom section. The bearing main body has an outer circumference and a shaft hole formed between the top section and the bottom section. The bearing main body is further formed with a stepped rest section between the outer circumference and the top section. The outer circumference is in contact with the bearing cup. A receiving space is defined between the rest section and the bearing cup. The fixing member is formed with a fixing section and a restriction section. The fixing section is disposed in the receiving space in abutment with the rest section. The restriction section is positioned at the top end of the bearing cup. The fixing section of the fixing member is positioned between the bearing main body and the bearing cup to fix the bearing main body in the bearing cup. In this case, the usable room of the bearing main body is effectively enlarged so that the support of the bearing main body is enhanced. Under such circumstance, the friction between the bearing main body and the shaft is reduced and the noise can be minimized. In addition, the amount of the lubricant retained in the bearing main body is increased and the lubrication between the bearing main body and the shaft can be maintained.

According to the above, the present invention has the following advantages:

1. The support between the shaft and the bearing is enhanced.

2. The shaft is prevented from shaking so that the noise can be minimized.

3. The amount of the lubricant retained in the bearing main body is increased and the lubrication between the bearing main body and the shaft is maintained.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a sectional assembled view of a conventional cooling fan;

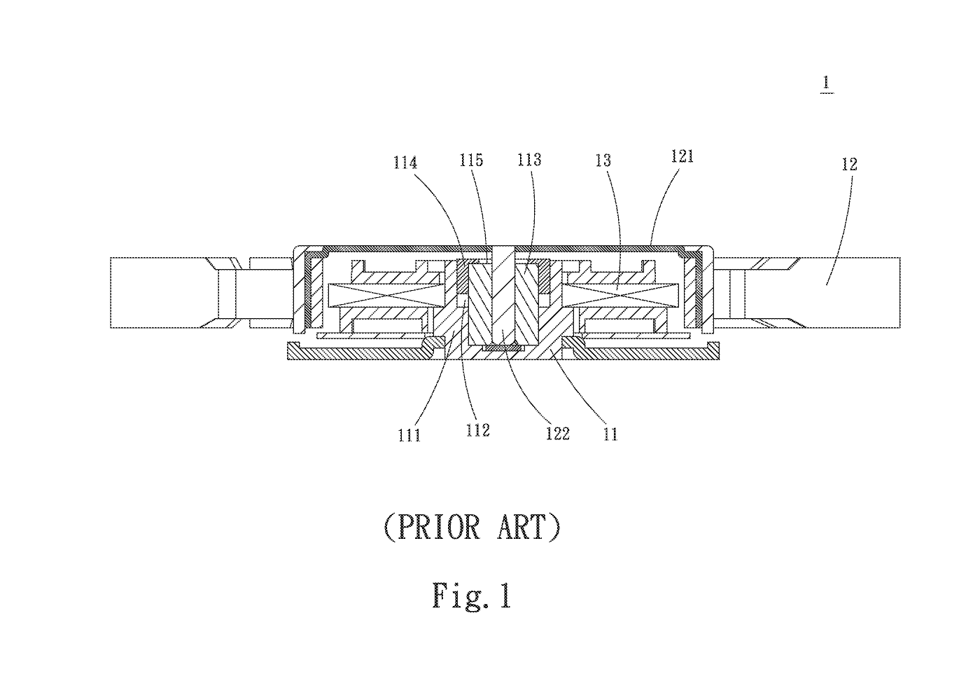

FIG. 2 is a perspective assembled view of a first embodiment of the oil-retaining bearing of the present invention;

FIG. 3 is a sectional exploded view of a first embodiment of the fixing structure of the oil-retaining bearing of the present invention;

FIG. 4A is a sectional assembled view of the first embodiment of the fixing structure of the oil-retaining bearing of the present invention;

FIG. 4B is a sectional assembled view of the first embodiment of the fixing structure of the oil-retaining bearing of the present invention in another aspect;

FIG. 5A is a sectional assembled view of a second embodiment of the fixing structure of the oil-retaining bearing of the present invention; and

FIG. 5B is another sectional assembled view of the second embodiment of the fixing structure of the oil-retaining bearing of the present invention.

### DETAILED DESCRIPTION OF THE PREFERRED EMBODIMENTS

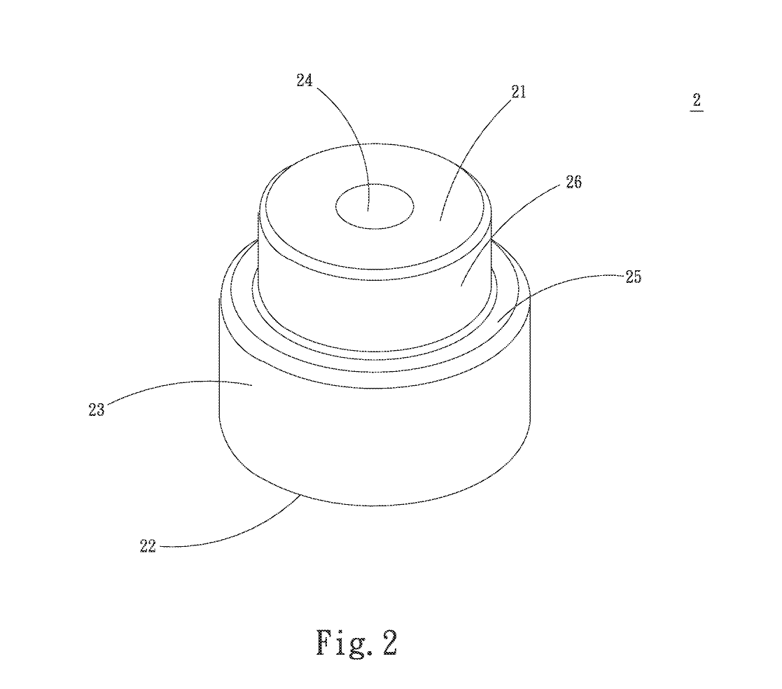

Please refer to FIG. 2, which is a perspective assembled view of a first embodiment of the oil-retaining bearing of the present invention. The oil-retaining bearing includes a bearing main body 2 having a top section 21 and a bottom section 22. The bearing main body 2 has an outer circumference 23 and a small-diameter abutment section 26, which are formed between the top section 21 and the bottom section 22. A stepped rest section 25 is defined between the outer circumference 23 and the abutment section 26. The abutment section 26 is positioned between the rest section 25 and the top section 21. A shaft hole 24 is formed at a center of the bearing main body 2 between the top section 21 and the bottom section 22. The width of the rest section 25 is smaller than the width of the bottom section 22. The length of the abutment section 26 is shorter than the length of the shaft hole 24.

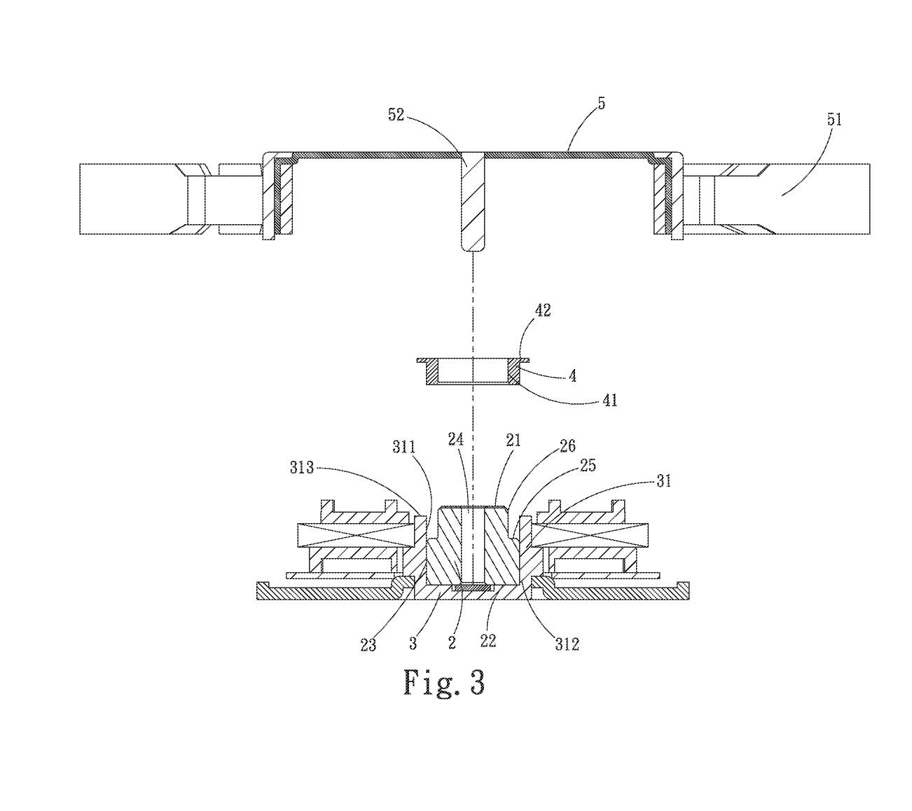

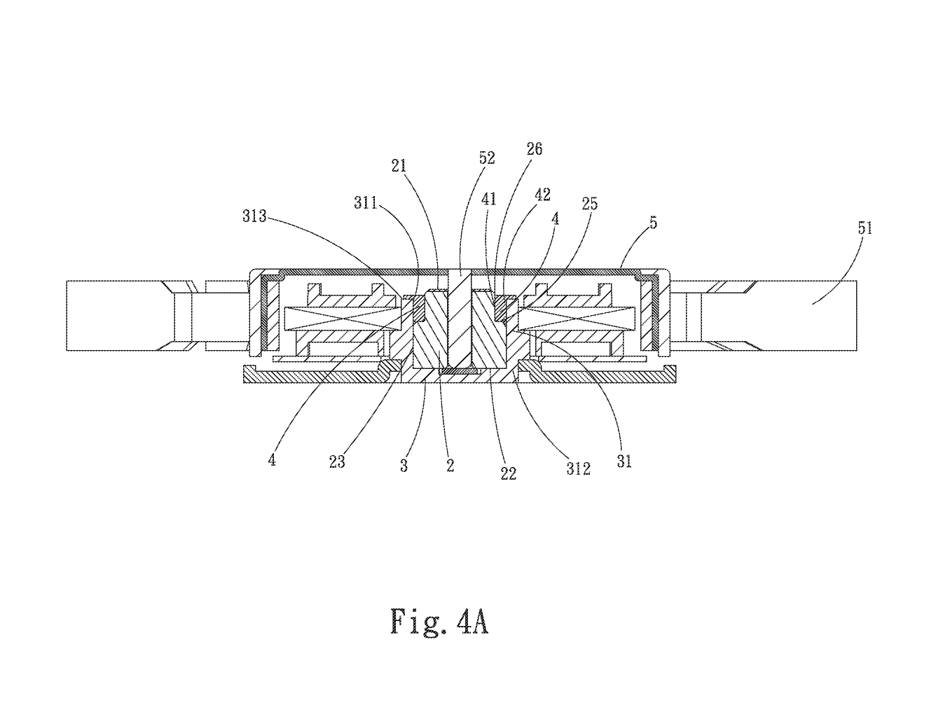

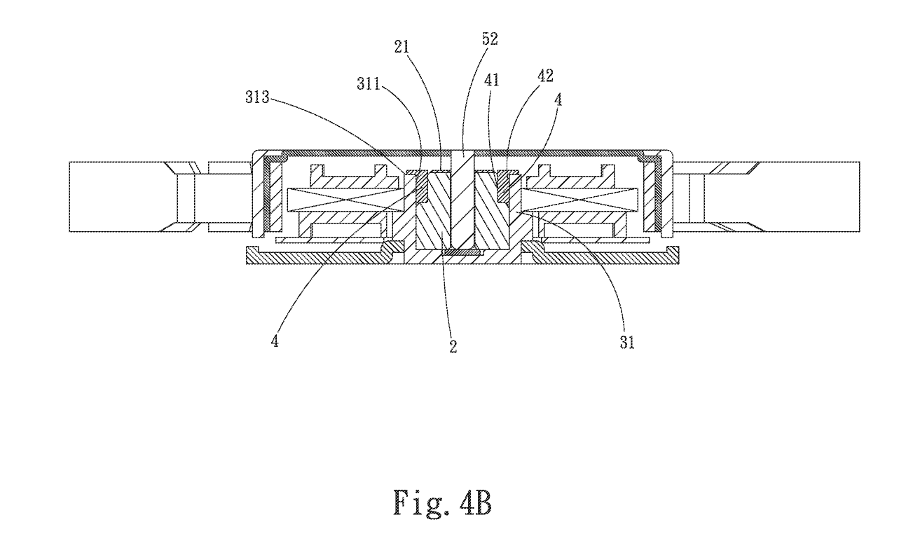

Please now refer to FIGS. 3 and 4A. FIG. 3 is a sectional exploded view of a first embodiment of the fixing structure of the oil-retaining bearing of the present invention. FIG. 4A is a sectional assembled view of the first embodiment of the fixing structure of the oil-retaining bearing of the present invention. According to the first embodiment, the fixing structure of the oil-retaining bearing of the present invention includes a base seat 3, a bearing main body 2 and at least one fixing member 4. A bearing cup 31 extends from one side of the base seat 3. The bearing cup 31 has a bearing hole 311, a fixed end 312 and a top end 313 opposite to the fixed end 312. The fixed end 312 is connected with the base seat 3. The bearing hole 311 is formed between the top end 313 and the fixed end 312. In practice, the base seat 3 can be made of metal material or plastic material. In this embodiment, the base seat 3 is made of metal material.

The bearing main body 2 is disposed in the bearing hole 311 of the bearing cup 31. The bearing main body 2 has a top section 21 and a bottom section 22. The bottom section 22 corresponds to the fixed end 312 of the bearing cup 31. The bearing main body 2 has an outer circumference 23 and a small-diameter abutment section 26, which are formed between the top section 21 and the bottom section 22. The outer circumference 23 is in contact with the bearing cup 31. A stepped rest section 25 is defined between the outer circumference 23 and the abutment section 26. The abutment section 26 is positioned between the rest section 25 and the top section 21. A receiving space is defined between the rest section 25, the abutment section 26 and the bearing cup 31. A shaft hole 24 is formed at a center of the bearing main body 2 between the top section 21 and the bottom section 22. The length of the abutment section 26 is shorter than the length of the shaft hole 24. The width of the rest section 25 is smaller than the width of the bottom section 22.

The fixing member 4 is formed with a fixing section 41 and a restriction section 42. The fixing section 41 is disposed in the receiving space in abutment with the rest section 25. The fixing section 41 can also abut against the abutment section 26 as necessary. In this embodiment, one end of the fixing section 41 abuts against the rest section 25 with one side attaching to the abutment section 26. The restriction section 42 is positioned at the top end 313 of the bearing cup 31 to effectively press down the bearing main body 2 into the bearing cup 31, whereby the bearing main body 2 is fixed in the bearing cup 31 by means of press fit. The fixing section 41 and the restriction section 42 of the fixing member 4 can be such positioned as to be flush with and/or lower than the top section 21 of the bearing main body 2.

A rotor assembly 5 is further disposed on the bearing main body 2. The rotor assembly 5 has multiple blades 51 and a shaft 52. The shaft 52 is passed through the bearing main body 2 and rotatably disposed in the shaft hole 24.

In this embodiment, the bearing main body 2 is disposed in the bearing hole 311 of the bearing cup 31. The fixing member 4 is fitted onto the top end 313 of the bearing cup 31 and the top section 21 of the bearing main body 2 to position the fixing section 41 of the fixing member 4 in the receiving space and press down the bearing main body 2 into the bearing cup 31. Accordingly, the bearing main body 2 is fixed in the bearing cup 31 by means of press fit. The restriction section 42 of the fixing member 4 is positioned at the top end 313 of the bearing cup 31. The fixing section 41 and the restriction section 42 of the fixing member 4 are such positioned as to be lower than the top section 21 of the bearing main body 2. In this case, the usable room of the bearing main body 2 is effectively enlarged and the length/size of the bearing main body 2 can be increased. Accordingly, the bearing main body 2 can have a sufficient length to enhance the support between the bearing main body 2 and the shaft 52. Under such circumstance, the friction between the bearing main body 2 and the shaft 52 is reduced and the noise can be minimized. In addition, the amount of the lubricant retained in the bearing main body 2 is increased and the lubrication between the bearing main body 2 and the shaft 52 can be maintained.

Please now refer to FIG. 4B, which is a sectional assembled view of the first embodiment of the fixing structure of the oil-retaining bearing of the present invention in another aspect. In practice, the bearing cup 31 can have different heights. In this embodiment, the bearing cup 31 has a higher height. The bearing main body 2 is disposed in the bearing hole 311 of the bearing cup 31. The fixing member 4 is fitted onto the top end 313 of the bearing cup 31 and the top section 21 of the bearing main body 2 to position the fixing section 41 of the fixing member 4 in the receiving space and press down the bearing main body 2 into the bearing cup 31. Accordingly, the bearing main body 2 is fixed in the bearing cup 31 by means of press fit. The restriction section 42 of the fixing member 4 is positioned at the top end 313 of the bearing cup 31. The fixing section 41 and the restriction section 42 of the fixing member 4 are positioned at a height equal to that of the top section 21 of the bearing main body 2. Similarly, the usable room of the bearing main body 2 is effectively enlarged and the length/size of the bearing main body 2 can be increased. Accordingly, the bearing main body 2 can have a sufficient length to enhance the support between the bearing main body 2 and the shaft 52. Under such circumstance, the friction between the bearing main body 2 and the shaft 52 is reduced and the noise can be minimized. In addition, the amount of the lubricant retained in the bearing main body 2 is increased and the lubrication between the bearing main body 2 and the shaft 52 can be maintained.

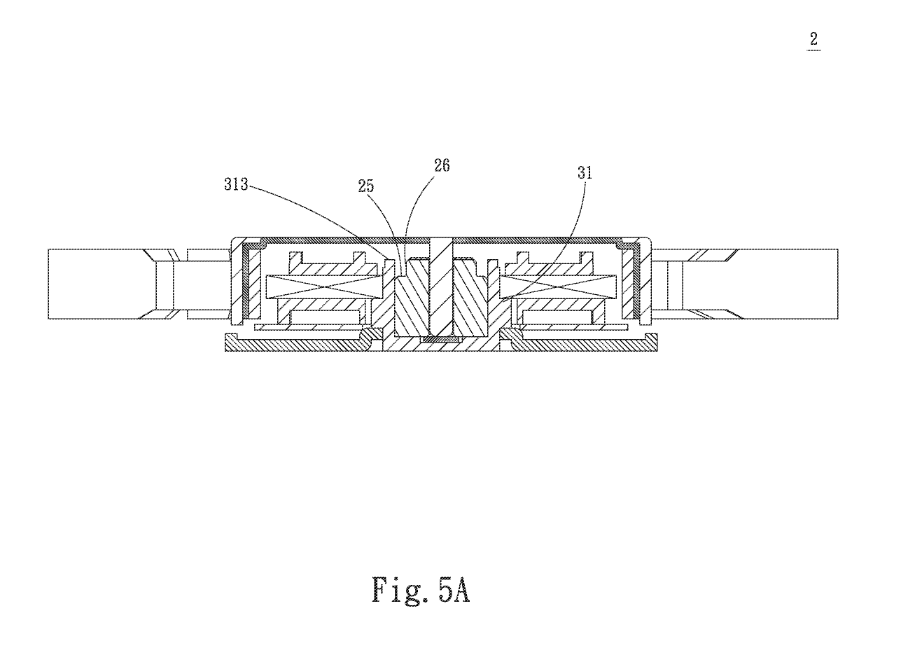

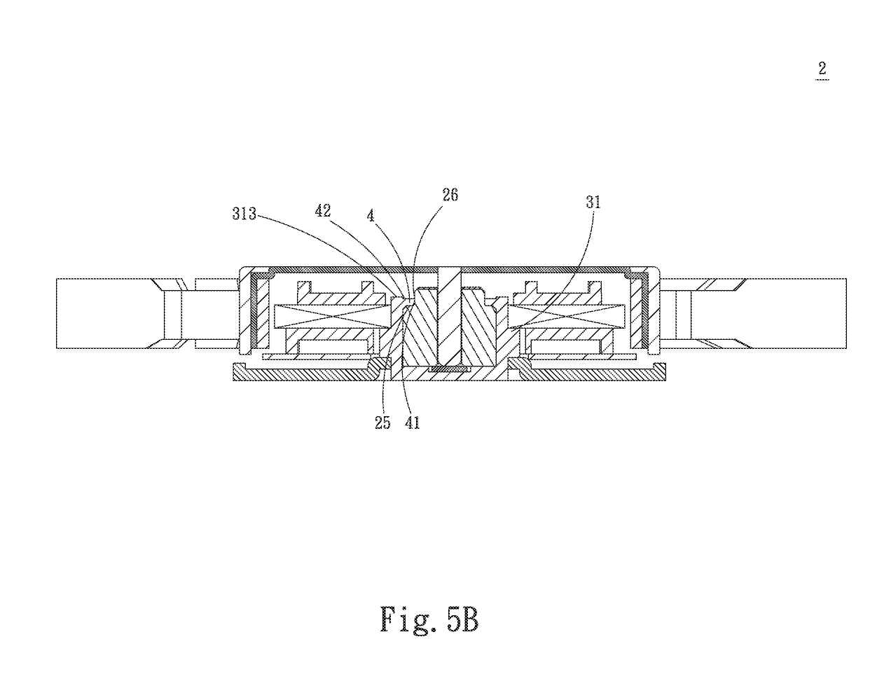

Please now refer to FIGS. 5A and 5B. FIG. 5A is a sectional assembled view of a second embodiment of the fixing structure of the oil-retaining bearing of the present invention. FIG. 5B is another sectional assembled view of the second embodiment of the fixing structure of the oil-retaining bearing of the present invention. In this embodiment, the base seat 3 is made of plastic material. After the bearing main body 2 is disposed in the bearing hole 311 of the bearing cup 31, the base seat 31 is molten to form the fixing member 4 having the fixing section 41 and the restriction section 42. The fixing section 41 is positioned in the receiving space defined by the abutment section 26, the rest section 25 and the bearing cup 31 to fix the bearing main body 2 in the bearing cup 31. The restriction section 42 of the fixing member 4 is positioned at the top end 313 of the bearing cup 31. In this case, the usable room of the bearing main body 2 is effectively enlarged and the length/size of the bearing main body 2 can be increased. Accordingly, the support between the bearing main body 2 and the shaft 52 is enhanced. Under such circumstance, the friction between the bearing main body 2 and the shaft 52 is reduced and the noise can be minimized. In addition, the amount of the lubricant retained in the bearing main body 2 is increased and the lubrication between the bearing main body 2 and the shaft 52 can be maintained.

The present invention has been described with the above embodiments thereof and it is understood that many changes and modifications in the above embodiments can be carried out without departing from the scope and the spirit of the invention that is intended to be limited only by the appended claims.

What is claimed is:

1. An oil-retaining bearing comprising:
a bearing main body having a top section and a bottom section, the bearing main body having an outer circumference and a shaft hole formed between the top section and the bottom section, the bearing main body being further formed with a stepped rest section between the outer circumference and the top section.

2. The oil-retaining bearing as claimed in claim 1, wherein the rest section has a width smaller than that of the bottom section.

3. The oil-retaining bearing as claimed in claim 1, wherein the bearing main body is further formed with an abutment section between the rest section and the top section.

4. The oil-retaining bearing as claimed in claim 3, wherein the abutment section has a length shorter than that of the shaft hole.

5. A fixing structure of an oil-retaining bearing, comprising:
a base seat, a bearing cup extending from one side of the base seat, the bearing cup having a bearing hole, a fixed end and a top end, the fixed end being connected with the base seat;
a bearing main body disposed in the bearing hole of the bearing cup, the bearing main body having a top section and a bottom section, the bearing main body having an outer circumference and a shaft hole formed between the top section and the bottom section, the bearing main body being further formed with a stepped rest section between the outer circumference and the top section, the outer circumference being in contact with the bearing cup, a receiving space being defined between the rest section and the bearing cup; and
at least one fixing member formed with a fixing section and a restriction section, the fixing section being disposed in the receiving space in abutment with the rest section, the restriction section being positioned at the top end of the bearing cup.

6. The fixing structure of the oil-retaining bearing as claimed in claim 5, further comprising a rotor assembly disposed on the bearing main body, the rotor assembly having multiple blades and a shaft, the shaft being passed through the bearing main body and rotatably disposed in the shaft hole.

7. The fixing structure of the oil-retaining bearing as claimed in claim 5, wherein the base seat is molten to form the fixing member having the fixing section and the restriction section.

8. The fixing structure of the oil-retaining bearing as claimed in claim 5, wherein the bearing main body is further formed with an abutment section between the rest section and the top section, the receiving space being defined between the abutment section, the rest section and the bearing cup.

9. The fixing structure of the oil-retaining bearing as claimed in claim 8, wherein the abutment section has a length shorter than that of the shaft hole.

10. The fixing structure of the oil-retaining bearing as claimed in claim 5, wherein the rest section has a width smaller than that of the bottom section.

11. The fixing structure of the oil-retaining bearing as claimed in claim 5, further comprising a stator assembly fitted around the bearing cup.

12. The fixing structure of the oil-retaining bearing as claimed in claim 1, wherein the base seat is made of metal material or plastic material.

13. The fixing structure of the oil-retaining bearing as claimed in claim 12, wherein the bearing cup of the base seat is molten to form the fixing member.
